(19) United States
(12) Patent Application Publication
(10) Pub. No.: US 2026/0318422 A1
(43) Pub. Date: Oct. 15, 2026

(54) VALVE HAVING CONTINUOUSLY VARIABLE FLOW STATES AND RESTRICTED FLOW STATE

(71) Applicant: Neptune Technology Group LLC, Tallassee, AL (US)

(72) Inventors: Wesley Scott Adkins, Auburn, AL (US); Jeffrey Keith Dorris, Wetumpka, AL (US); Jonathan Lamar Pearce, Tuscaloosa, AL (US); Mitchell Alan Milner, Tallassee, AL (US); Jeffrey M. Fowler, Lawrenceville, GA (US)

(21) Appl. No.: 19/643,487

(22) Filed: Apr. 9, 2026

Related U.S. Application Data
(60) Provisional application No. 63/786,595, filed on Apr. 10, 2025.

(51) Int. Cl. F16K 3/26; G01F 15/00

(52) U.S. Cl. CPC F16K 3/26; G01F 15/005

(57) ABSTRACT

A valve assembly for a water meter is provided. The valve assembly includes a casing comprising an internal cavity, an inlet port, and an outlet port; and a valve member configured to move within the internal cavity. The valve member comprises: a first orifice having a first size; and a second orifice having a smaller second size. The valve member is configured to selectively move to multiple different positions within the casing, including: a first target position permitting a first fluid flow between the inlet port and the outlet port through the first orifice; a second target position permitting a second fluid flow between the inlet port and the outlet port through the second orifice, a flow rate of the second fluid flow less than a flow rate of the first fluid flow; and a third target position permitting no fluid flow between the inlet port and the outlet port.

### CLAIM OF PRIORITY

This application claims priority under 35 USC §119(e) to U.S. Patent Application Serial No. 63/786,595, filed on Apr. 10, 2025, the entire contents of which are hereby incorporated by reference.

### BACKGROUND OF THE INVENTION

Water metering systems are being developed that include features to automatically shut off or control flow to metered premises. Valves can be used to implement such flow controls. When used with water meters, the valves need to meet service parameters that correspond to overall meter requirements for reliability, service life, power consumption, replacement, and the like.

A valve, such as a valve associated with a water meter for controlling a flow of water to a point of use, may advantageously afford a restricted flow state. When the valve is in the restricted flow state, the flow of water is greatly reduced relative to a fully open state. The reduced flow is sufficient for humanitarian purposes, such as basic sanitation, cooking, and drinking.

### SUMMARY

Valves, such as diaphragm valves, gate valves, ball valves, or plug valves, may be configured with an intentional leak in a "closed" state. For example, a valve associated with a water meter may be configured to provide limited flow when in closed position by using a pinhole or eliminating a gasket. Such solutions may afford a repeatably precise restricted flow, but they do not afford a shut-off state, such as a drip-tight state. Other conventional valves, such as gate valves, ball valves, or plug valves, may be continuously controlled such that flow is partially restricted. Depending on numerous factors, such as part variation, backlash, variation in feedback measurements of valve position, and the like, requirements for repeatability and precision of the flow restriction may be expensive, difficult, or impossible to meet with conventional valves.

According to exemplary implementations described herein, a valve, such as a valve incorporated with a water meter, may have continuously variable flow states, a restricted flow state, and a fully closed state. The valve may be operated by a suitable battery-operated valve control mechanism. The valve may provide ease of assembly, accurate positioning, dependable actuation, and minimal power use (e.g., small range of motion, low required torque, etc.). The valve may provide restricted flow through an orifice that is separate from the variable main orifice. The restricted flow orifice provides consistent restricted flow rates even at low pressure and is not sensitive to minor misalignment or calibration errors.

According to an exemplary embodiment, a valve assembly includes a casing including an internal cavity, an inlet port, and an outlet port; and a valve member configured to move within the internal cavity of the casing, the valve member including: a first orifice having a first size; and a second orifice having a second size that is smaller than the first size. The valve member is configured to be selectively moved to multiple different positions within the casing, the multiple different positions including: a first target position that permits a first fluid flow between the inlet port and the outlet port through the first orifice; a second target position that permits a second fluid flow between the inlet port and the outlet port through the second orifice, a flow rate of the second fluid flow being less than a flow rate of the first fluid flow; and a third target position that permits no fluid flow between the inlet port and the outlet port.

In some implementations, the valve assembly further includes: a seal assembly including: a liner insert configured to sit at least partially within the outlet port; and a gasket configured to form a seal between an outer surface of the valve member and an inner surface of the casing when the valve member is positioned within the internal cavity of the casing.

In some implementations, the valve assembly further includes: a liner configured to fit within the internal cavity of the casing and around an outer surface of the valve member. An inner surface of the liner defines a channel that permits fluid flow around at least a portion of the outer surface of the valve member when the valve member is positioned within the liner.

In some implementations, the second target position permits the second fluid flow between the inlet port and the outlet port through the channel, the first orifice, and the second orifice.

In some implementations, a rate of the second fluid flow is insensitive to positional variation of the valve member over a range of up to 10 degrees of rotation from the second target position.

In some implementations, the inlet port, the outlet port, and the first orifice are aligned along a common flow axis when the valve member is in the first target position. The inlet port, the outlet port, and the first orifice are not aligned along the common flow axis when the valve member is in the second target position.

In some implementations, the valve member includes a cylinder configured to rotate within the casing. The first orifice includes a transverse bore through the cylinder.

In some implementations, the second orifice includes a pinhole bore that extends between the transverse bore and an outer surface of the cylinder.

In some implementations, the valve member is a rotating valve member configured to rotate within the casing. The valve assembly further includes a rotor configured to impart rotational movement to the rotating valve member.

In some implementations, the valve member further includes a third orifice having a third size that is smaller than the first size. A fourth target position that permits third fluid flow between the inlet port and the outlet port through the third orifice.

In some implementations, the valve member includes a gate element to selectively open and close the first orifice, and the gate element includes the second orifice, the second orifice having a circular or oblong shape.

According to an exemplary embodiment, a valve assembly includes: a casing including an internal cavity, an inlet port, and an outlet port; a valve member configured to rotate within the internal cavity of the casing, the valve member including: a first orifice having a first size; and a second orifice having a second size that is smaller than the first size; and a rotor configured to impart rotational movement to the valve member. The valve member is configured to be selectively rotated to multiple different positions within the casing, the multiple different positions including: a first target position that permits a first fluid flow between the inlet port and the outlet port through the first orifice; a second target position that permits a second fluid flow between the inlet port and the outlet port through the second orifice, a flow rate of the second fluid flow being less than a flow rate of the first fluid flow; and a third target position that permits no fluid flow between the inlet port and the outlet port.

In some implementations, the first orifice includes a bore through the valve member and the second orifice extends from a mid-section of the bore to an outer surface of the valve member.

In some implementations, the flow rate of the second fluid flow is no more than fifteen percent of the flow rate of the first fluid flow.

In some implementations, the second orifice is configured to adjustably permit a flow range of up to fifteen percent of a configured fluid flow rate of the first orifice.

In some implementations, the valve assembly includes: a motor configured to impart rotational motion to the rotor; a valve controller configured to control the motor to selectively rotate the valve member to the first target position, the second target position, and the third target position; and a battery to power the valve controller and the motor.

In some implementations, the second target position provides a fluid flow rate that is insensitive to positional variation of the valve member over a range of up to 10 degrees of rotation.

According to an exemplary embodiment, a method of regulating flow through a valve, where the valve including a casing with an inlet port and an outlet port and a valve member configured to move within the casing, includes: moving the valve member to a first target position that permits a first fluid flow between the inlet port and the outlet port through a first orifice of the valve member; moving the valve member to a second target position that permits a second fluid flow between the inlet port and the outlet port through a second orifice of the valve member, a flow rate of the second fluid flow being less than a flow rate of the first fluid flow; and moving the valve member to a third target position that permits no fluid flow between the inlet port and the outlet port.

In some implementations, moving the valve member to the second target position includes: moving the valve member from the first target position to the second target position with rotational movement of no more than 95 degrees.

In some implementations, moving the valve member to the third target position includes: moving the valve member from the first target position to the third target position with rotational movement of no more than 95 degrees.

The details of one or more implementations are set forth in the accompanying drawings and the description herein. Other features, objects, and advantages will be apparent from the description and drawings, and from the claims.

### BRIEF DESCRIPTION OF THE DRAWINGS

FIG. 1 is an exploded perspective view of a plug valve for a water meter according to an exemplary embodiment;

FIGS. 2A-2F are schematic cross-sectional views of a rotary valve in different orientations, according to an implementation described herein;

FIG. 3A illustrates a perspective view, front view, and side cross-sectional view of the seal assembly of FIG. 1;

FIG. 3B illustrates a perspective view, front view, and side view of the liner insert of FIG. 3A;

FIG. 3C illustrates a top view, side view, and perspective view of the gasket of FIG. 3A;

FIG. 4A is a side view of the plug of FIG. 1, according to an implementation;

FIG. 4B is a side cross-sectional view of the plug of FIG. 4A;

FIG. 4C is a top cross-sectional view of the plug of FIG. 4A;

FIG. 5 is a side view of a section of the liner of FIG. 1, according to an implementation;

FIG. 6A is a diagram illustrating an environment in which systems and methods described here may be implemented;

FIG. 6B is a diagram illustrating exemplary electronic components of a meter assembly, according to an implementation;

FIGS. 7A-7C are schematic cross-sectional views of a rotary valve in different orientations, according to another implementation described herein;

FIGS. 8A-8C are schematic cross-sectional views of a gate valve in different orientations, according to another implementation described herein;

FIGS. 9A and 9B are perspective views of plugs, according to another implementation;

FIGS. 10A and 10B are schematic side views of different embodiments of a gate for a gate valve, according to other implementations;

FIGS. 10C and 10D are schematic cross-sectional views of a gate valve in different orientations, according to another implementation described herein; and

FIG. 11 is a flow diagram for a process for operating a valve, according to an implementation.

### DETAILED DESCRIPTION

The following detailed description refers to the accompanying drawings. The same reference numbers in different drawings identify the same or similar elements.

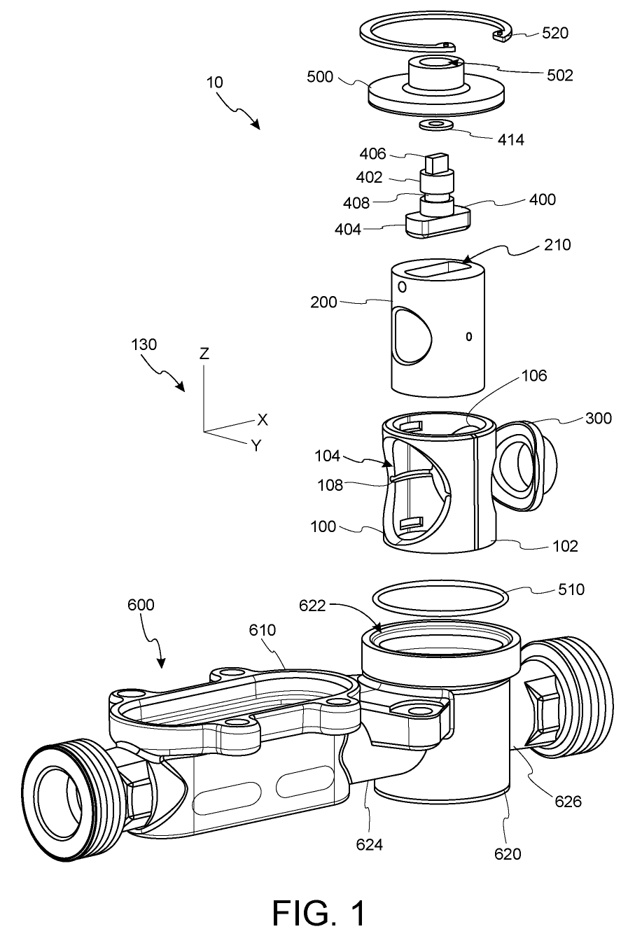

FIG. 1 provides an assembly view of an exemplary valve configured to have continuously variable flow states and a restricted flow state. Referring to FIG. 1, a top-loaded rotary valve 10 is shown, according to an implementation. Rotary valve 10 can include a liner 100, a plug 200, an outlet seal assembly 300, a rotor 400, and a cover 500. In some implementations, valve 10 can be installed in a pressure vessel 600 that includes a meter casing 610 and a valve casing 620. Valve 10 and valve casing 620 may be referred to herein collectively as a valve assembly.

Liner 100 can include a generally cylindrical structure configured to be received in pressure vessel 600. Liner 100 can include a cylindrical wall 102 with flow openings 104 and 106 that are configured to align with openings of valve casing 620 and permit flow into and out of valve 10. Flow openings 104/106 may form a generally circular opening through cylindrical wall 102, such that a central axis of openings 104/106 (e.g., corresponding to the X-axis as defined by the coordinate system 130 shown in FIG. 1) is orthogonal to a central axis of cylindrical wall 102 (e.g., corresponding to the Z-axis shown in FIG. 1). The orientation of liner 100 may be fixed relative to valve casing 620.

According to an implementation, liner 100 can include one or more channels 108 extending between openings 104 and 106 along an interior surface of cylindrical wall 102. As described further herein, channels 108 can generally permit fluid, such as water, to enter a main bore of plug 200 and enable fluid flow through a pinhole orifice at lower inlet pressures.

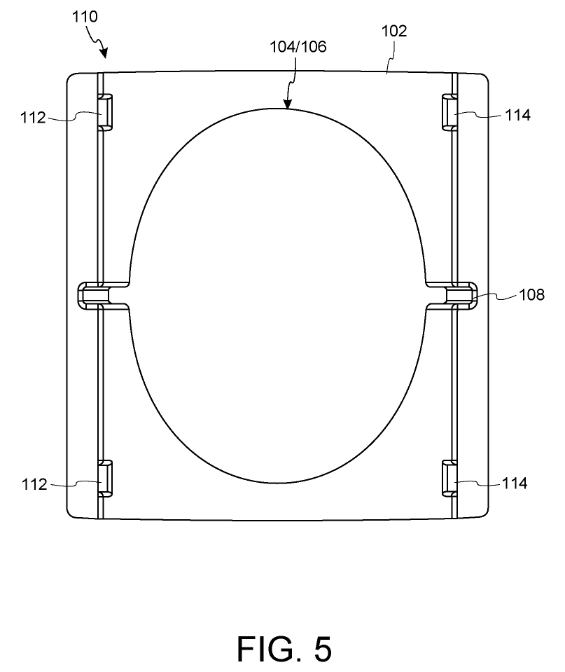

Referring to FIG. 5, in some implementations, liner 100 can be formed by joining two identical half-cylinders, such as half-cylinder 110. For example, during installation of valve 10, a first half-cylinder 110 can be inserted into valve casing 620 to align with seal assembly 300. A second half-cylinder 110 can be inserted and joined to the first half-cylinder 110 to complete liner 100. For example, tabs 112 can clip into corresponding slots 114 to secure half-cylinders 110 together inside valve casing 620. According to an implementation, liner 100 can be formed of a molded plastic material. For example, half-cylinders 110 can be formed from an engineered polymer (a reinforced engineering thermoplastic, such as Polyphenylene Ether (PPE) or Polyphenylene Oxide (PPO).

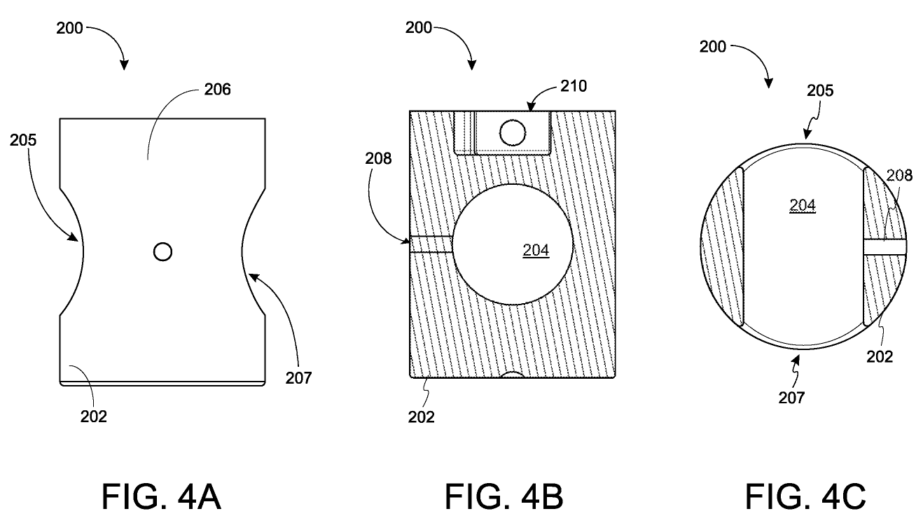

Referring collectively to FIGS. 1 and 4A-4C, plug 200 may be a rotating valve member configured to rotate within liner 100. Plug 200 can include a generally solid cylinder 202 (with an axis aligned along the "z" axis shown in FIG. 1) with a transverse bore 204 having an axis (e.g., corresponding to the "x" axis shown in FIG. 1) that is orthogonal to the axis of solid cylinder 202. Cylinder 202 includes an outer surface 206. Transverse bore 204 can extend between openings 205 and 207 through the outer surface 206. As described further herein, plug 200 can also include at least one pinhole 208 (also referred to as a restricted orifice) through cylinder 202 that extends from a mid-section of bore 204 to outer surface 206. In some implementations, an axis of pinhole 208 (e.g., corresponding to the "y" axis shown in FIG. 1) is oriented perpendicular to the axis of transverse bore 204. Pinhole 208 can be substantially smaller in size (e.g., diameter) than bore 204. Thus, fluid flow through pinhole 208 can be restricted to a relatively low rate, sufficient for basic humanitarian purposes, for example. The pinhole 208 can have a circular or oblong shape.

Dimensions of pinhole 208 and flow rates permitted by pinhole 208 may vary in implementations. In some implementations, pinhole 208 has a diameter between 5% and 50% of the diameter of bore 204 (e.g., no more than 5%, no more than 10%, no more than 20%, no more than 30%, no more than 40%, no more than 50%, between 5% and 15%, between 10% and 20%, between 20% and 30%, between 30% and 40%, between 40% and 50%, etc., of the diameter of the bore 204). In an example, the pinhole 208 has a diameter of 5/64 inches and the bore 204 has a diameter of 5/8 inches.

In some implementations, pinhole 208 can be configured to permit between 2% and 20% of the configured flow rate through bore 204 at typical pressures (e.g., no more than 5%, no more than 10%, no more than 15%, no more than 20%, between 2% and 8%, between 5% and 10%, between 8% and 15%, between 10% and 20%, between 15% and 20%, etc., of the configured flow rate through the bore 204). In an example, the pinhole 208 permits between 0.5 gallons per minute (gpm) and 1.5 gpm when a nominal flow rate through the bore 204 is 25 gpm with the valve 10 in a fully open state.

Plug 200 can also include a rotor mount 210 for rotor 400. Rotor mount 210 can include a recess in a top portion of plug 200 that is aligned, for example, on a central axis of the plug 200 (e.g., parallel to the Z- axis shown in FIG. 1). As described further herein, rotor 400 can be configured to engage plug 200 at rotor mount 210, such that rotation of rotor 400 causes rotation of plug 200 relative to liner 100.

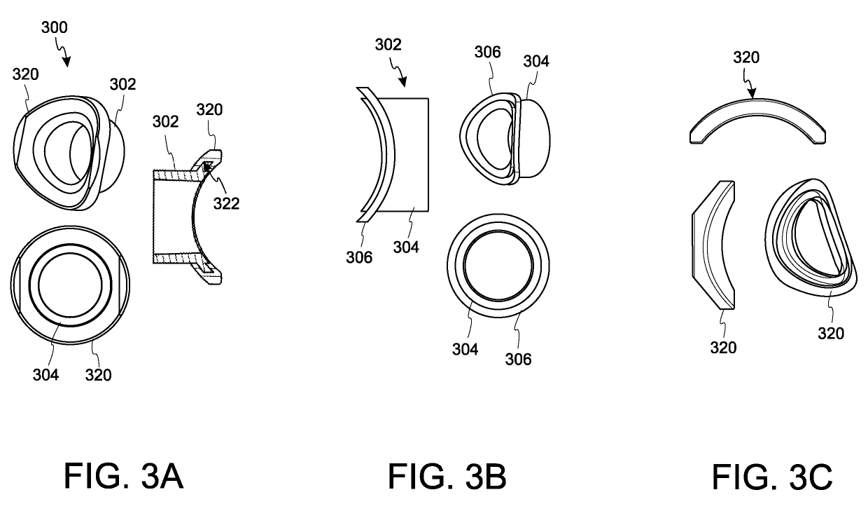

Referring collectively to FIGS. 1 and 3A-3C, seal assembly 300 can include a liner insert 302 and a gasket 320. Liner insert 302 can include a cylinder 304 with a contoured flange 306. Cylinder 304 can be configured with an outside diameter that fits within an outlet 626 of valve casing 620. As shown, for example, in FIG. 3B, contoured flange 306 may have a shape that generally matches a shape of a portion of an intersecting cylinder, e.g., the cylindrical body 622. For example, the shape of the contoured flange 306 may match a shape of the portion of the cylindrical body 622 where outlet 626 is formed into the cylindrical body 622 of valve casing 620. Liner insert 302 can be somewhat rigid and formed, for example, from the same material used for liner 100. Contoured flange 306 provides a sealing ridge onto which a gasket (e.g., gasket 320) can be mounted. Contoured flange 306, with gasket 320 mounted thereon, provides a stopping point for insertion of cylinder 304 into outlet 626.

Gasket 320 can include a continuous elliptical body or gasket that includes an inner groove 322. As shown, for example, in FIG. 3A, gasket 320 can be installed over contoured flange 306. Generally, the dimensions of gasket 320 can be configured to match the shape of contoured flange 306 and/or the intersecting cylinders where outlet 626 is formed into cylindrical body 622 of valve casing 620. More particularly, dimensions of groove 322 can be configured to fit onto contoured flange 306 such that gasket 320 provides a resilient compressible material along the edge of flow opening 106 and against outer surface 206 of plug 200.

Gasket 320 can be constructed of any suitably durable and elastomeric material, such as silicone, butyl rubber polyamide, polyester, olefin, styrenics, urethane, and a composite of a thermoplastic and cured rubber. More specific examples include room temperature vulcanization silicone, uncured ethylene-propylene-diene-monomer (EPDM) blended with polypropylene, styrene-butadiene-styrene block polymer, styrene-ethylene-butylene-styrene block polymer, cured ethylene-propylene-diene copolymer/polypropylene blend, cured isobutylene isoprene rubber/polypropylene blend, and cured nitrile butadiene rubber / polyvinylchloride blend.

Rotor 400 can include a stem 402 connecting a base 404 and an actuation tip 406. Stem 402 can generally be oriented along a common axis with plug 200 (e.g., in the direction of the Z-axis shown in FIG. 1). Stem 402 can include a radial groove 408 between base 404 and actuation tip 406. Groove 408 can be configured to hold an O-ring 414. O-ring 414 can include a flexible material similar to, for example, that of gasket 320. Base 404 can be located at an end (e.g., a lower end) of stem 402. Base 404 can be configured to fit within rotor mount 210 and engage plug 200, such that rotation of base 404 causes rotation of plug 200.

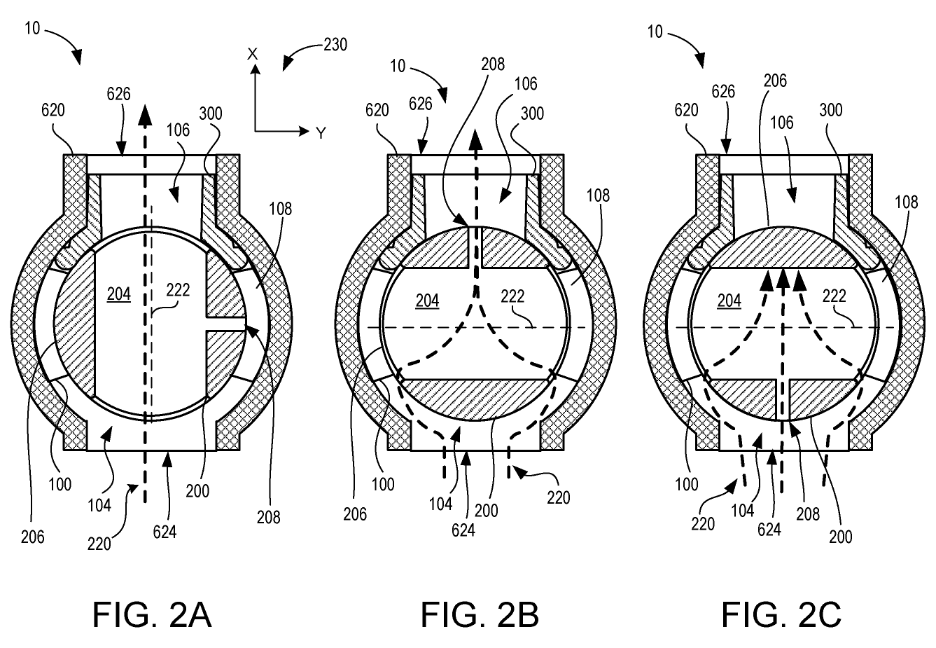

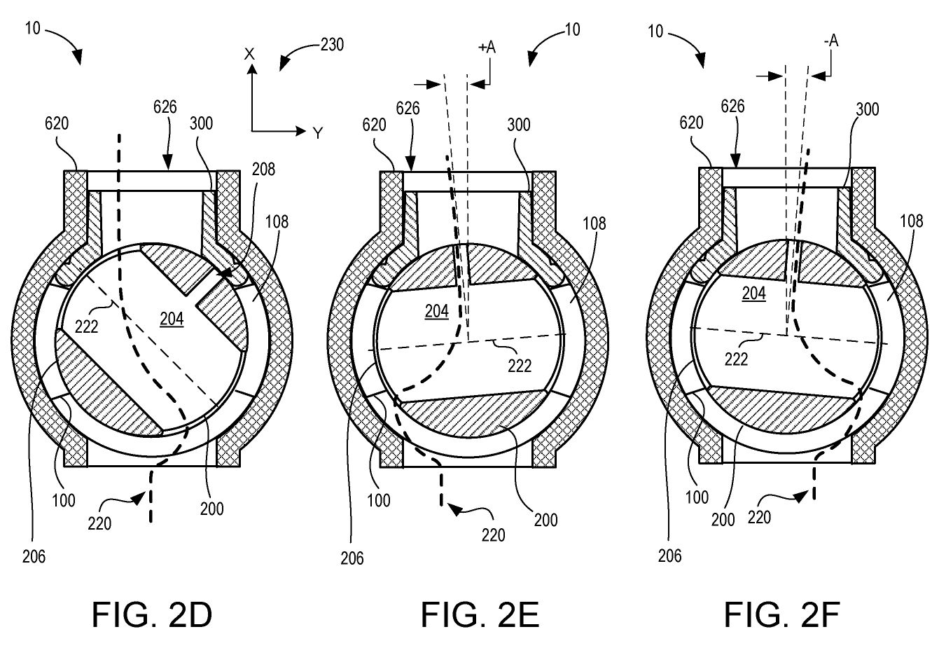

Actuation tip 406 can be located at an end (e.g., an upper end) of stem 402. Actuation tip 406 can extend beyond cover 500 to expose stem 402 to application of external forces. For example, actuation tip 406 can include one or more contact surfaces to which an actuator, a motor, or another device can apply rotational forces to rotor 400. In some implementations, actuation tip 406 is integral with or connected to a rotary actuator or motor. According to one embodiment, rotor 400 can rotate plug 200 between a fully open position (e.g., FIG. 2A, described further below), a restricted flow position (e.g., FIG. 2B, described further below), and a fully closed position (e.g., FIG. 2C, described further below).

Cover 500 can include a substantially disc-shaped structure with an access hole 502. In some implementations, cover 500 can be formed from a metal material, such as bronze. In some implementations, cover 500 can be formed from a plastic material. Access hole 502 can be configured to receive actuation tip 406 of rotor 400 therethrough. Cover 500 can be installed through the opening of cylindrical body 622 of valve casing 620 to secure liner 100, plug 200 and rotor 400 within valve casing 620. For example, in some implementations, cover 500 can include threads on an outer diameter that correspond to threads on an interior surface of valve casing 620, such that cover 500 can be screwed into valve casing 620. An O-ring seal 510 can be interposed between cover 500 and an inner shoulder of cylindrical body 622 to form a fluid-tight interface therebetween.

When cover 500 is installed onto valve casing 620, plug 200, rotor 400, and access hole 502 can share a common actuating axis (e.g., along the Z-axis orientation of FIG. 1). A portion of stem 402 can extend through access hole 502, such that grooves 408 and O-ring 414 align with the interior surface of cover 500 within access hole 502 to form a fluid-tight interface. Thus, the interface between valve casing 620 and cover 500 can be a fluid-tight interface.

Pressure vessel 600 can include meter casing 610 and valve casing 620. In some implementations, pressure vessel 600 can be made from a metal material, such as a casted metal (e.g., bronze), with machined cavities to form meter casing 610 and valve casing 620. Meter casing 610 can include an opening to receive a water meter (not shown). In the configuration of FIG. 1, fluid can flow through the water meter/meter casing 610 to valve casing 620.

Valve casing 620 can include a cavity to hold components of valve 10, such as liner 100, plug 200, seal assembly 300, rotor 400, and cover 500. The cavity of valve casing 620 can include cylindrical body 622 (e.g., a cylindrical volume) that is closed at the bottom and configured to receive valve 10 through a top opening. Valve casing 620 can include an inlet 624 and an outlet 626 which define a flow channel with a flow axis extending in the X-direction. Flow of fluid through the flow channel can be selectively controlled by valve 10. Inlet 624 can align with flow opening 104 of liner 100, and outlet 626 can align with opening 106 of liner 100, such that inlet 624, flow opening 104, flow opening 106, and outlet 626 share a common flow axis (e.g., aligned with the X-axis). In some implementations, inlet 624, flow opening 104, flow opening 106, and outlet 626 have parallel flow axes.

In the example shown in FIG. 1, valve casing 620 can be configured to be top-loaded; that is, the working elements of valve 10 can be loaded on an axis (e.g., the Z-axis) perpendicular to the axis of fluid flow through valve casing 620. The top-loaded arrangement can simplify assembly and allow for valve repair and/or replacement without disconnecting pressure vessel 600 from other system piping. In other implementations, valves internals can be end-loaded.

Valve casing 620 can be generally configured, along with cover 500, to enclose valve 10 without limiting access to flow opening 104 and flow opening 106. In some implementations, cylindrical body 622 includes one or more indexing tabs (not shown) to ensure correct orientation of liner 100 relative to casing 620 and to prevent rotation of liner 100 relative to casing 620. Cylindrical body 622 can have an inside diameter that is nominally larger than the outer diameter of liner 100, such that liner 100 fits snugly within valve casing 620. At the top of cylindrical body 622, valve casing 620 can be sized to receive cover 500 therein. The upper portion of cylindrical body 622 can include internal threads to receive cover 500. In some implementations, the upper portion of cylindrical body 622 can include a groove above the installed depth of cover 500. The groove can receive a clip 520 to lock cover in place.

While description herein is described primarily in the context of a plug valve, in other implementations a ball valve or another rotating valve member may be used to implement the continuously variable flow states and a restricted flow state described herein. In still other implementations, a gate valve may be used to implement the continuously variable flow states and a restricted flow state described herein.

FIGS. 2A-2F illustrate concepts described herein. FIGS. 2A-2F show a schematic top cross-sectional view of an embodiment of valve 10. Referring to FIG. 2A, in a first orientation or target position, valve 10 is in a fully open state. Bore 204 of plug 200 is substantially aligned with inlet 624 and outlet 626, such that the inlet 624, the bore 204, and the outlet 626 form a flow channel through which a fluid 220 can flow along a common flow axis that is substantially parallel to or aligned with a center axis 222 of the bore 204. In some examples, the bore 204 has a cylindrical shape, and the center axis 222 is the cylindrical axis of the bore 204.

In the example of FIG. 2A, the common flow axis of the fluid 220 and the center axis 222 of the bore 204 both extend in the X-direction as defined by coordinate system 230. In some examples, a diameter of the bore 204 is the same as an inner diameter of the inlet 624, the outlet 626, or both. In some examples, the diameter of the bore 204 is narrower than the inner diameter of the inlet 624, the outlet 626, or both.

Referring to FIG. 2B, in a second orientation or target position, valve 10 is in a restricted state. To reach the second target position from the first target position, the plug 200 is rotated counter-clockwise about 90 degrees from the orientation in FIG. 2A. When the valve 10 is in the second orientation, the center axis 222 of the bore 204 is substantially aligned with the Y-direction, which is perpendicular to the center axis 222 of the bore 204 when the valve 10 is in the first orientation.

Referring to FIG. 2C, in a third orientation or target position, valve 10 is in a closed state. To reach the third target position from the first target position, the plug 200 is rotated clockwise by about 90 degrees from the orientation in FIG. 2A. When the valve 10 is in the third orientation, the center axis 222 of the bore 204 is substantially aligned with the Y-direction, which is perpendicular to the center axis 222 of the bore 204 when the valve 10 is in the first orientation. To reach the third target position from the second target position, the bore 204 of the plug 200 is rotated approximately 180 degrees in either the clockwise direction or counter-clockwise direction.

In the second and third orientations of FIGS. 2B and 2C, outer surface 206 of plug 200 seals only the outlet side of the valve 10 at outlet 626. The inlet end of the valve 10 at inlet 624 can be unsealed, permitting flow of fluid between inlet 624 and bore 204. Additionally, in some implementations, liner 100 includes one or more channels 108 to permit higher flow rates from inlet 624 into bore 204.

In the second orientation of FIG. 2B, pinhole 208 is positioned between the bore 204 and the outlet 626. The pinhole 208 communicates fluid between bore 204 and outer surface 206 of plug 200, such that pinhole 208 allows a restricted flow between bore 204 and outlet 626. In this manner, fluid can flow from the unsealed end at flow opening 104 into bore 204, and from bore 204 through pinhole 208 past seal assembly 300 to outlet 626. The diameter of pinhole 208 can be substantially smaller than the diameter of bore 204, as previously described. Channels 108 can aid fluid flow into bore 204 to better enable flow through pinhole 208 at lower inlet pressures.

In the third orientation of FIG. 2C, seal assembly 300 substantially prevents fluid from flowing between inlet 624 and outlet 626. In the third orientation, the pinhole 208 is positioned between the bore 204 and the inlet 624 and communicates fluid between the inlet 624 and the bore 204. In this manner, fluid may flow from the unsealed end at flow opening 104 into the bore 204 through the pinhole 208, the channel 108, or both. Fluid does not exit the bore 204 through the opening 106, which is sealed by the seal assembly 300 and the outer surface 206 of the plug 200.

According to some implementations, a plurality of intermediate orientations of plug 200 may be available, where the center axis 222 of the bore 204 may partially align with the X-direction, such that flow between the inlet 624 and the outlet 626 is partially restricted. Thus, adjustable flow rates can be provided through bore 204. The ability to adjust the flow rate of fluid through the bore 204 by adjusting the orientation of the plug 200 enables the valve 10 to function as a variable flow rate valve that provides continuously variable flow states. For example, when moving from the orientation shown in FIG. 2C to the orientation shown in FIG. 2A, the plug 200 can rotate in a counterclockwise direction. When the bore 204 begins to align with the inlet 624 and the outlet 626, a passage is created that permits some fluid to flow between the inlet 624 and the outlet 626 through the bore. The size of the passage increases as the center axis 222 comes into alignment with the X-direction. When the center axis 222 is aligned with the X-direction (as shown in FIG. 2A), the size of the passage is maximized and maximum flow is achieved through the plug 200. To move from the orientation shown in FIG. 2A to the orientation shown in FIG. 2B, the plug 200 can continue to rotate in the counterclockwise direction. During the rotation, the size of the passage gradually decreases, therefore decreasing flow rate through the plug as the center axis 222 moves away from alignment with the X-direction. Eventually the bore 204 becomes blocked at the outlet side by the seal assembly 300, while the pinhole 208 becomes free of the seal assembly 300 and open to the outlet 626. The valve 10 then permits restricted flow between the inlet 624 and the outlet 626 through the pinhole 208 via the bore 204, as shown in FIGS. 2B, 2E, and 2F. Thus, as described, the valve 10 can be operated to permit variable flow rates from zero flow rate up to a maximum flow rate, including continuously variable restricted flow rates in between the zero flow rate and the maximum flow rate.

FIG. 2D illustrates an orientation of the plug 200 which provides partial restriction of flow through bore 204. In the example of FIG. 2D, fluid 220 can pass through the inlet 624, through the bore 204, and through the outlet 626, even though the center axis 222 of the bore 204 is not aligned with the X-direction.

In contrast, pinhole 208 can generally provide a consistent flow at a range of orientations and is insensitive to positional variation of plug 200 over a range of positions. FIGS. 2E and 2F, for example, illustrate positional variations of plug 200/pinhole 208 relative to a target axis. Seal assembly 300 can engage cylinder 202 and prevent flow through transverse bore 204 for a range of angular misalignment +A (FIG. 2E) to -A (FIG. 2F) from a target orientation where an axis of the pinhole 208 is parallel to the X-axis as defined by the coordinate system 230. For example, when A is 5 degrees, plug 200 can provide consistent flow rates through pinhole 208 for up to about 10 degrees of rotation from a target position. Accordingly, plug 200 can rotate counterclockwise up to 95 degrees from a full open state (FIG. 2A) and achieve a restricted state orientation or can rotate clockwise up to 95 degrees from the full open state and achieve a closed state orientation.

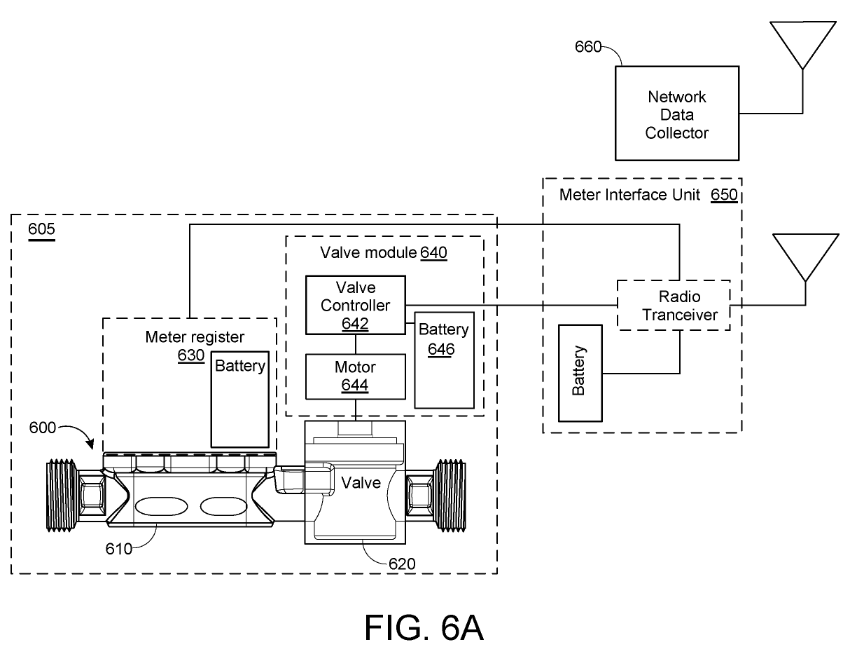

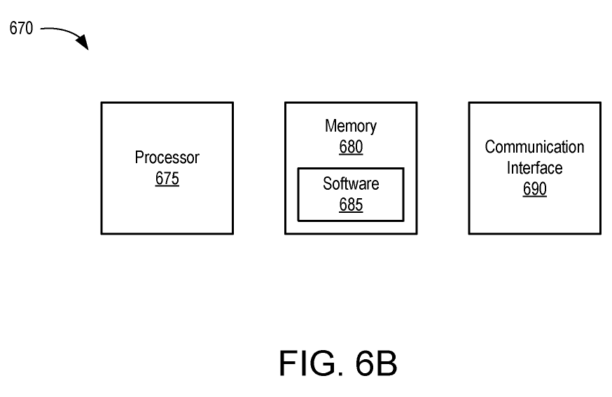

FIG. 6A is a diagram illustrating an environment in which systems and methods described here may be implemented. As shown in FIG. 6A, a water meter assembly 605 can include pressure vessel 600 with water meter casing 610 and valve casing 620. Valve casing 620 can include valve 10 as described herein. Water meter assembly 605 can also include a meter register 630 and a valve module 640.

Meter register 630 can include a device that is operatively connected to the water meter and attached to water meter casing 610. Meter register 630 can, for example, record metering data from the water meter and communicate with a meter interface unit (MIU), such as MIU 650. For example, meter register 630 can periodically respond to queries from MIU 650 to provide recorded metering data.

Valve module 640 can be operatively connected to valve 10 and attached to valve casing 620 and/or the valve assembly. Valve module 640 can include a valve controller 642, a motor 644, and a battery 646. Valve controller 642 can control the position and/or state of valve 10 in valve casing 620.

Valve controller 642 can include a processor and/or logic circuitry that executes one or more processes/functions. Valve controller 642 can include ports for receiving and sending data, including sending control instructions and receiving control acknowledgements, from motor 644 or from another unit, such as MIU 650. For example, valve controller 642 can assign one of a continuously variable flow state, a restricted flow state, or a closed state for valve 10. In some implementations, valve controller 642 can receive valve state instructions from MIU 650, for example. Motor 644 can physically implement commands from valve controller 642. For example, motor 644 can move/rotate rotor 400 to align plug 200 in an orientation directed by valve controller 642. Battery 646 can power valve controller 642 and motor 644. Battery 646 can include a disposable battery, a rechargeable battery, or another electrical power source for supplying power to valve controller 642 and motor 644.

MIU 650 can include a device that collects, analyzes and stores data from meter register 630. MIU 650 can also provide instructions and/or collect state information from valve module 640. In some implementations, MIU 650 can be integrated into meter register 630. That is, meter register 630 and MIU 650 can be a single component. In other implementations, MIU 650 or a portion of MIU 650 can be a separate component from meter register 630. For example, MIU 650 can be located externally with respect to meter register 630 and can be coupled to meter register 630 via a wired or wireless connection. MIU 650 can also include one or more wireless transmitters and receivers to provide wireless communication capability for transmitting a current meter reading.

Network data collector 660 can include a network device that communicates with MIU 650 to receive data and/or provide instructions related to water meter assembly 605. Network data collector 660 can obtain network data to determine water usage levels, valve state data, billing data, usage metrics, and other data that can be compiled with data, for example, from other water meter assemblies 605.

FIG. 6B is a diagram illustrating exemplary components 670 that can be included in one or more of meter register 630, valve controller 642, MIU 650, and network data collector 660. As illustrated in FIG. 6B, the components 670 can include a processor 675, a memory 680, and a communication interface 690. According to some embodiments, memory 680 can store software 685. According to other embodiments, fewer components, additional components, and/or different components than those illustrated in FIG. 6B and described herein, may be implemented.

Processor 675 can include one or multiple processors, microprocessors, microcontrollers, application specific integrated circuits (ASICs), programmable logic devices, chipsets, field-programmable gate arrays (FPGAs), application specific instruction-set processors (ASIPs), system-on-chips (SoCs), central processing units (CPUs) (e.g., one or multiple cores), neural processing units (NPUs), quantum processors, future generation processor, and/or some other type of component that interprets and/or executes instructions and/or data. Processor 675 can be implemented as hardware (e.g., a microprocessor, etc.), a combination of hardware and software (e.g., a SoC, an ASIC, etc.), can include one or multiple memories (e.g., cache, etc.), etc.

Memory 680 can include one or multiple memories and/or one or multiple other types of storage mediums. For example, memory/storage 680 can include a random access memory (RAM), a dynamic RAM (DRAM), a static RAM (SRAM), a cache, a read only memory (ROM), a programmable ROM (PROM), an erasable PROM (EPROM), an electrically erasable PROM (EEPROM), a solid state memory, a flash memory, or the like.

Software 685 can include an application or a program that provides a function and/or a process. As an example, with reference to valve controller 642, software 685 can include an application that, when executed by processor 675, provides a function and/or a process to change a valve state, test valve 10, or calibrate valve 10. According to another example, network data collector 660 can include software 685 that collects and/or analyzes data from water meter assembly 605. Software 685 can include software, firmware, middleware, microcode, hardware description language (HDL), and/or another form of instruction.

Communication interface 690 can permit apparatus described herein to communicate with other devices, networks, network devices, systems, and/or the like. Communication interface 690 can include a wireless interface, an optical interface, and/or a wired interface. For example, communication interface 690 can include one or multiple transmitters and receivers, or transceivers. Communication interface 690 can operate according to a protocol stack and a communication standard. Communication interface 690 can support one or multiple transmission/reception configurations. MIU 650 can include communication interface 690 to exchange data with network data collector 660, for example.

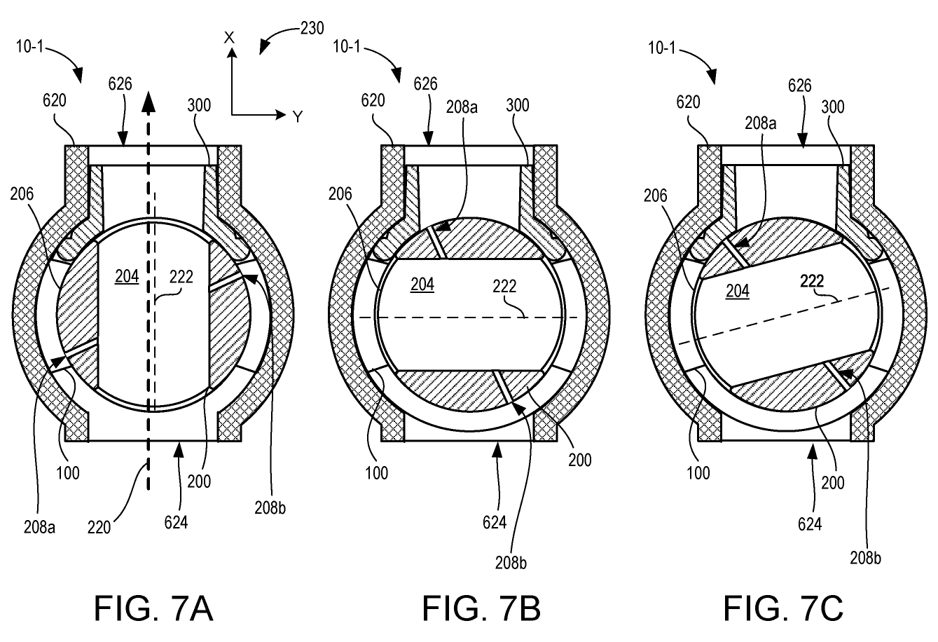

FIGS. 7A-7C illustrate concepts described herein according to another implementation. In contrast to FIGS. 2A-2F, FIGS. 7A-7C show a schematic top cross-sectional view of an embodiment of valve 10-1 with two restricted orifices (i.e., pinhole orifices 208a and 208b). The arrangement of FIGS. 7A-7C may allow for cycling among an open state, a restricted state, and a closed state without changing a direction of rotation and with a lesser total rotation from the closed state, through the open or restricted state, back to the closed state (e.g., half a revolution compared to a full revolution).

Referring to FIG. 7A, in a first orientation or target position, valve 10-1 is in an open state. Bore 204 of plug 200 is substantially aligned with inlet 624 and outlet 626, such that the inlet 624, the bore 204, and the outlet 626 form a flow channel through which the fluid 220 can flow along a common axis that is substantially parallel to or aligned with the center axis 222 of the bore 204. In the example of FIG. 7A, the common flow axis of the fluid 220 and the center axis 222 of the bore 204 both extend in the X-direction as defined by coordinate system 230. In some implementations, intermediate orientations of plug 200 may be possible, where the center axis 222 of the bore 204 partially aligns with the X-axis for a more limited flow between the inlet 624 and the outlet 626.

Referring to FIG. 7B, in a second orientation or target position, valve 10-1 is in a restricted state. To reach the second target position from the first target position, the plug 200 is rotated counter-clockwise by about 90 degrees from the orientation in FIG. 7A. When the valve 10-1 is in the second orientation, the center axis 222 of the bore 204 is substantially aligned with the Y-direction, which is perpendicular to the center axis 222 of the bore 204 when the valve 10-1 is in the first orientation.

In the second orientation of FIG. 7B, outer surface 206 of plug 200 seals the outlet side of the valve 10-1 at outlet 626. The inlet end of the valve 10-1 at inlet 624 can be unsealed, permitting flow of fluid between inlet 624 and bore 204. Additionally, in some implementations, liner 100 can include one or more channels 108 (FIG. 1) to permit higher flow rates from inlet 624 into bore 204.

In the second orientation of FIG. 2B, pinhole 208a is positioned between the bore 204 and the outlet 626. The pinhole 208a communicates fluid between bore 204 and outer surface 206 of plug 200, such that pinhole 208 allows a restricted flow between bore 204 and outlet 626. In this manner, fluid can flow from the unsealed end at inlet 624 into bore 204, and from bore 204 through pinhole 208a past seal assembly 300.

Referring to FIG. 7C, in a third orientation or target position, valve 10-1 is in a closed state. To reach the third target position from the second target position, the plug 200 is rotated counterclockwise about 10 degrees from the second orientation in FIG. 7B. In this orientation, the seal assembly 300 prevents flow from exiting bore 204 into outlet 626. Similarly, seal assembly 300 prevents flow from exiting pinhole 208a into outlet 626. In the third orientation of FIG. 7C, seal assembly 300 substantially prevents any fluid from flowing between inlet 624 and outlet 626.

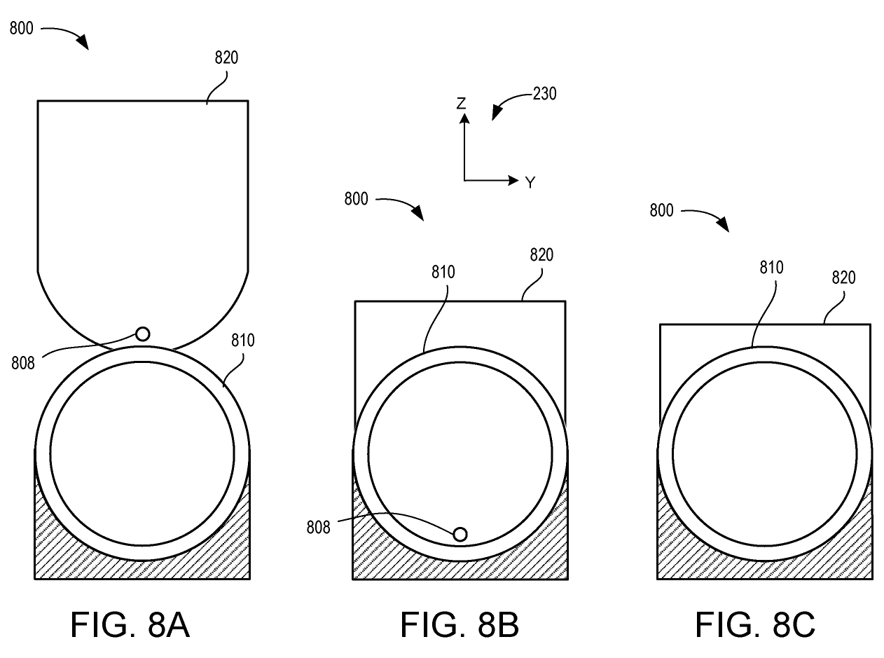

FIGS. 8A-8C are a schematic end cross-sectional view of an embodiment of a gate valve 800 according to another implementation. Gate valve 800 can include a cylindrical inner housing 810 with a flow path therethrough. The flow path can extend along the X-direction (e.g., into the page of FIGS. 8A-8C). A gate 820 (also referred to herein as a valve member) seals against a surface of housing 810 to prevent flow past gate 820. Gate 820 can include a pinhole 808 (or a restricted orifice) through the thickness of gate 820. Pinhole 808 can be sized and function similarly to pinhole 208 described above for providing a restricted flow through valve 800. Gate 820 can be selectively raised and lowered to transition valve 800 between a fully open state shown in FIG. 8A, a restricted state shown in FIG. 8B, and a closed state shown in FIG. 8C. For example, valve module 640 (FIG. 6A) can use a linear actuator (e.g., a rack and pinion, screw, or another system to impart liner movement), a motor, and/or another device to selectively position gate 820 within valve 800.

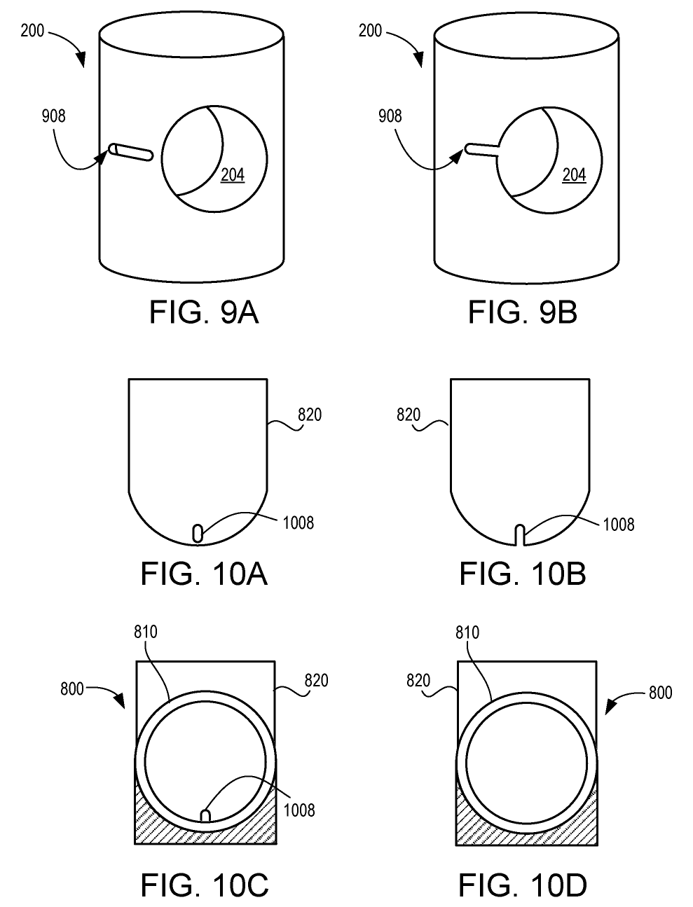

FIGS. 9A and 9B are schematics of plug 200 according to another implementation. As shown in FIG. 9A, plug 200 can include a small orifice 908 that is elongated, or oblong, such that a length of the orifice 908 is greater than a width of the orifice 908. The length extends in the direction of motion/rotation of plug 200. Plug 200 can rotate in a manner similar to that described above in connection with FIGS. 1 and 7A-7C between an open state, a restricted state, and a closed state. Additionally, in the restricted state, the amount of orifice 908 that is not blocked by seal assembly 300 can be adjusted to provide variable restricted flow through orifice 908. Similarly, referring to FIG. 9B, plug 200 can include small orifice 908 that is contiguously connected to bore 204 and extends in the direction of motion/rotation of plug 200.

FIGS. 10A-10D are a schematic end cross-sectional view of an embodiment of a gate valve 800 according to another implementation. FIGS. 10A and 10B are alternative embodiments of gate 820 including a small orifice 1008 (or a restricted orifice) that is elongated, or oblong, such that a length of the orifice 1008 is greater than a width of the orifice 1008. The length extends in the direction of motion of gate 820. Orifice 1008 can be sized and function similarly to orifice 908 described above for providing a restricted flow through valve 800. Gate 820 can move in a manner similar to that described above in connection with FIGS. 8A-8C between an open state, a restricted state, and a closed state. As shown in FIG. 10C, gate 820 can be selectively lowered from an open state (e.g., FIG. 8A) to transition valve 800 between a variable restricted state shown in FIG. 10C and a closed state shown in FIG. 10D.

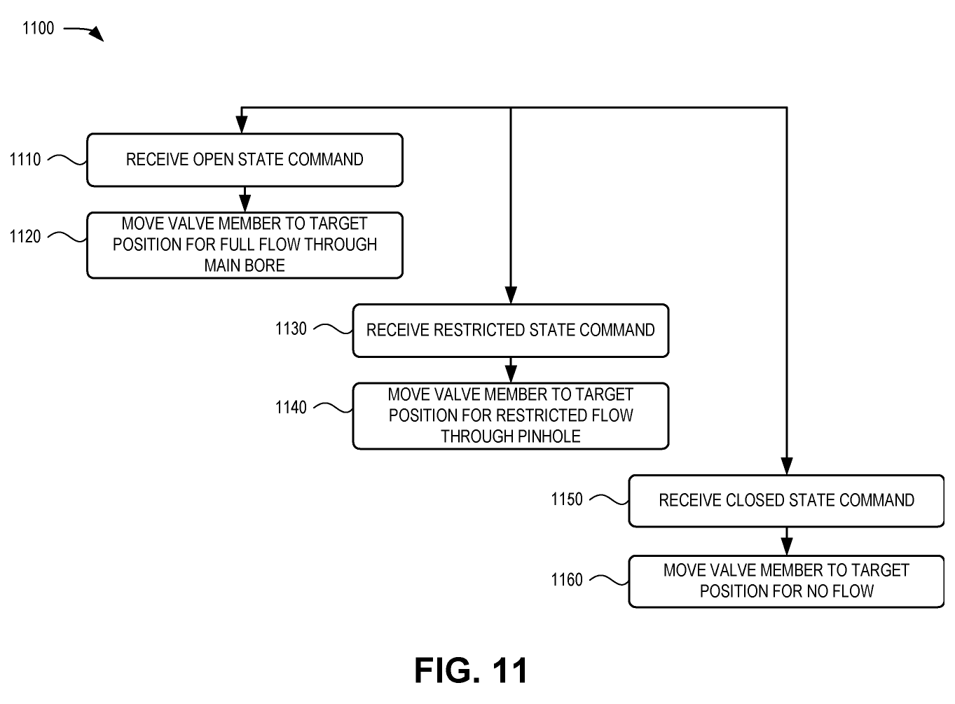

FIG. 11 is a flow diagram of an exemplary process 1100 for operating a valve, such as valve 10, according to an implementation. Process 1100 can include receiving an open state command (block 1110) and moving a valve member to a target position for full flow through a main bore (block 1120). For example, valve controller 642 can receive a signal from MIU 650 to open valve 10. In response, valve controller 642 can control motor 644 to rotate plug 200 so that main bore 204 is aligned with flow channel 628, as shown in FIGS. 2A, 7A, and 8A.

Process 1100 can also include receiving a restricted state command (block 1130) and moving a valve member to a target position for restricted flow through a pinhole (block 1140). For example, valve controller 642 can receive a signal from MIU 650 to transition to a restricted flow. In response, valve controller 642 can control motor 644 to rotate plug 200 so that pinhole 208 receives fluid through main bore 204 and expels fluid into outlet 626, as shown in FIGS. 2B, 7B, 8B, and 10C.

Process 1100 can also include receiving closed state command (block 1150) and moving a valve member to a target position for no flow through (block 1160). For example, valve controller 642 can receive a signal from MIU 650 to transition to a closed state. As another example, valve controller 642 can receive a signal to transition to restricted state based on a stored schedule aligned with a clock of meter assembly 605. In response, valve controller 642 can control motor 644 to rotate plug 200 so that neither main bore 204 nor pinhole 208 can and expel fluid into outlet 626, as shown in FIGS. 2C, 7C, 8C, and 10D.

The foregoing description of implementations provides illustration and description, but is not intended to be exhaustive or to limit the invention to the precise form disclosed. Modifications and variations are possible in light of the above teachings or may be acquired from practice of the invention.

Use of ordinal terms such as "first," "second," "third," etc., in the claims to modify a claim element does not by itself connote any priority, precedence, or order of one claim element over another, the temporal order in which acts of a method are performed, the temporal order in which instructions are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the articles "a," "an," and "the" are intended to include one or more items. Further, the phrase "based on" is intended to mean "based, at least in part, on" unless explicitly stated otherwise. The term "and/or" is intended to be interpreted to include any and all combinations of one or more of the associated items. The word "exemplary" is used herein to mean "serving as an example." Any embodiment or implementation described as "exemplary" is not necessarily to be construed as preferred or advantageous over other embodiments or implementations. The term “substantially” is used herein to represent a degree by which a quantitative representation may vary from a stated reference without resulting in a change in the basic function of the subject matter at issue.

As set forth in this description and illustrated by the drawings, reference is made to "an exemplary embodiment," "an embodiment," "embodiments," etc., which may include a particular feature, structure or characteristic in connection with an embodiment(s). However, the use of the phrase or term "an embodiment," "embodiments," etc., in various places in the specification does not necessarily refer to all embodiments described, nor does it necessarily refer to the same embodiment, nor are separate or alternative embodiments necessarily mutually exclusive of other embodiment(s). The same applies to the term "implementation," "implementations," etc.

With reference to the use of the words "including" or "comprising" in the foregoing description and/or in the following claims, unless the context requires otherwise, those words are used on the basis and clear understanding that they are to be interpreted inclusively, rather than exclusively, and that each of those words is to be so interpreted in construing the foregoing description and the following claims.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A valve assembly comprising:
a casing comprising an internal cavity, an inlet port, and an outlet port; and
a valve member configured to move within the internal cavity of the casing, the valve member comprising:
a first orifice having a first size; and
a second orifice having a second size that is smaller than the first size,
wherein the valve member is configured to be selectively moved to multiple different positions within the casing, the multiple different positions comprising:
a first target position that permits a first fluid flow between the inlet port and the outlet port through the first orifice;
a second target position that permits a second fluid flow between the inlet port and the outlet port through the second orifice, a flow rate of the second fluid flow being less than a flow rate of the first fluid flow; and
a third target position that permits no fluid flow between the inlet port and the outlet port.

2. The valve assembly of claim 1, further comprising:
a seal assembly comprising:
a liner insert configured to sit at least partially within the outlet port; and
a gasket configured to form a seal between an outer surface of the valve member and an inner surface of the casing when the valve member is positioned within the internal cavity of the casing.

3. The valve assembly of claim 1, further comprising:
a liner configured to fit within the internal cavity of the casing and around an outer surface of the valve member, wherein an inner surface of the liner defines a channel that permits fluid flow around at least a portion of the outer surface of the valve member when the valve member is positioned within the liner.

4. The valve assembly of claim 3, wherein the second target position permits the second fluid flow between the inlet port and the outlet port through the channel, the first orifice, and the second orifice.

5. The valve assembly of claim 1, wherein a rate of the second fluid flow is insensitive to positional variation of the valve member over a range of up to 10 degrees of rotation from the second target position.

6. The valve assembly of claim 1, wherein the inlet port, the outlet port, and the first orifice are aligned along a common flow axis when the valve member is in the first target position, and
wherein the inlet port, the outlet port, and the first orifice are not aligned along the common flow axis when the valve member is in the second target position.

7. The valve assembly of claim 1, wherein the valve member includes a cylinder configured to rotate within the casing, and wherein the first orifice comprises a transverse bore through the cylinder.

8. The valve assembly of claim 7, wherein the second orifice comprises a pinhole bore that extends between the transverse bore and an outer surface of the cylinder.

9. The valve assembly of claim 1, wherein the valve member is a rotating valve member configured to rotate within the casing, and
wherein the valve assembly further comprises a rotor configured to impart rotational movement to the rotating valve member.

10. The valve assembly of claim 1, wherein the valve member further comprises a third orifice having a third size that is smaller than the first size, and
wherein a fourth target position that permits third fluid flow between the inlet port and the outlet port through the third orifice.

11. The valve assembly of claim 1, wherein the valve member includes a gate element to selectively open and close the first orifice, and
wherein the gate element includes the second orifice, the second orifice having a circular or oblong shape.

12. A valve assembly, comprising:
a casing comprising an internal cavity, an inlet port, and an outlet port;
a valve member configured to rotate within the internal cavity of the casing, the valve member including:
a first orifice having a first size; and
a second orifice having a second size that is smaller than the first size; and
a rotor configured to impart rotational movement to the valve member,
wherein the valve member is configured to be selectively rotated to multiple different positions within the casing, the multiple different positions comprising:
a first target position that permits a first fluid flow between the inlet port and the outlet port through the first orifice;
a second target position that permits a second fluid flow between the inlet port and the outlet port through the second orifice, a flow rate of the second fluid flow being less than a flow rate of the first fluid flow; and
a third target position that permits no fluid flow between the inlet port and the outlet port.

13. The valve assembly of claim 12, wherein the first orifice comprises a bore through the valve member and the second orifice extends from a mid-section of the bore to an outer surface of the valve member.

14. The valve assembly of claim 12, wherein the flow rate of the second fluid flow is no more than fifteen percent of the flow rate of the first fluid flow.

15. The valve assembly of claim 12, wherein the second orifice is configured to adjustably permit a flow range of up to fifteen percent of a configured fluid flow rate of the first orifice.

16. The valve assembly of claim 12, further comprising:
a motor configured to impart rotational motion to the rotor;
a valve controller configured to control the motor to selectively rotate the valve member to the first target position, the second target position, and the third target position; and
a battery to power the valve controller and the motor.

17. The valve assembly of claim 12, wherein the second target position provides a fluid flow rate that is insensitive to positional variation of the valve member over a range of up to 10 degrees of rotation.

18. A method of regulating flow through a valve, the valve comprising a casing with an inlet port and an outlet port and a valve member configured to move within the casing, the method comprising:
moving the valve member to a first target position that permits a first fluid flow between the inlet port and the outlet port through a first orifice of the valve member;
moving the valve member to a second target position that permits a second fluid flow between the inlet port and the outlet port through a second orifice of the valve member, a flow rate of the second fluid flow being less than a flow rate of the first fluid flow; and
moving the valve member to a third target position that permits no fluid flow between the inlet port and the outlet port.

19. The method of claim 18, wherein moving the valve member to the second target position includes:
moving the valve member from the first target position to the second target position with rotational movement of no more than 95 degrees.

20. The method of claim 18, wherein moving the valve member to the third target position includes:
moving the valve member from the first target position to the third target position with rotational movement of no more than 95 degrees.
